(19) United States
(12) Patent Application Publication
(10) Pub. No.: US 2009/0213902 A1
(43) Pub. Date: Aug. 27, 2009

(54) AUTOMATIC FREQUENCY HOPPING AND CHANNEL TRACKING SYSTEM FOR AUTO-FREQUENCY-HOPPING DIGITAL WIRELESS MICROPHONE

(76) Inventor: Ming-Fure Jeng, Yingge Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/038,024

(22) Filed: Feb. 27, 2008

(51) Int. Cl. H04B 1/00

(52) U.S. Cl. 375/133; 375/E01.033

(57) ABSTRACT

An automatic frequency hopping and channel tracking system for an auto-frequency-hopping digital wireless microphone includes a digital wireless microphone and a digital wireless receiving device. In the event of receiving from the digital wireless microphone a signal having an abnormal quality, the digital wireless receiving device not only automatically switches to another signal receiving channel but also intermittently or periodically generates and transmits an RF signal to the digital wireless microphone, so that the latter automatically switches its signal channel to another signal channel according to the RF channel information. In this manner, the digital wireless microphone and receiving device are able to synchronously and quickly switch to another signal channel to avoid the abnormal signal channel and thereby keep good signal transmission therebetween.

### FIELD OF THE INVENTION

The present invention relates to an automatic frequency hopping and channel tracking system for an auto-frequency-hopping digital wireless microphone, and more particularly to an automatic frequency hopping and channel tracking system for an auto-frequency-hopping digital wireless microphone that enables the digital wireless microphone to perform automatic frequency hopping based on detected radio frequency (RF) channel information and switch from a poor signal channel to a good one.

### BACKGROUND OF THE INVENTION

The situation of frequency conflict frequently occurs in using conventional wireless microphones when there are two or more users.

Currently, the technique of automatic frequency hopping is adopted to avoid noises or overlapped channels. By “automatic frequency hopping”, it means when a transmitting end and a receiving end synchronously and simultaneously transmit signals using a specific type of narrow-band wave, the transmitting and receiving ends may simultaneously switch to another band when a poor data transmission quality has continued over a very short time period, so as to avoid the transmission from being interfered by noises within the specific narrow band.

### SUMMARY OF THE INVENTION

A primary object of the present invention is to provide an automatic frequency hopping and channel tracking system for a digital wireless microphone. The system of the present invention includes a digital wireless microphone that has a first digital RF transmitter and a first digital RF receiver; and a digital wireless receiving device that has a second digital RF receiver, a receiving quality detector, a channel selector, and a second digital RF transmitter. When the second digital RF receiver receives a wireless signal transmitted by the first digital RF transmitter and the receiving quality detector detects that the received wireless signal is poor in quality, the receiving quality detector would generate and transmit an enable signal to the second digital RF receiver and the second digital RF transmitter. The second digital RF transmitter receiving the enable signal generates an RF signal, which is intermittently or periodically transmitted to the first digital RF receiver, so that the first digital RF transmitter follows the RF signal received by the first digital RF receiver to switch its current signal channel to a low-interference wireless signal channel selected by the channel selector. Meanwhile, the second digital RF receiver receiving the enable signal also switches its receiving channel to the low-interference wireless signal channel selected by the channel selector. In this manner, it is able to avoid the current abnormal signal channel and to transmit and receive signal without being interfered. Thereafter, RF signal transmission from the second digital RF transmitter stops when a preset period of time has lapsed or when the receiving quality detector determines the quality of received signal has reached a preset level.

Another object of the present invention is to provide an automatic frequency hopping and channel tracking system for a digital wireless microphone. The system of the present invention includes a digital wireless microphone that has a first digital RF transmitter, a first digital RF receiver, and a decoder; and a digital wireless receiving device that has a second digital RF receiver, a receiving quality detector, a channel selector, and a second digital RF transmitter. In this manner, when a signal transmission between the digital wireless microphone and the digital wireless receiving device is poor in quality, the digital wireless microphone and the digital wireless receiving device may synchronously switch their signal channel to the low-interference wireless signal channel selected by the channel selector to thereby maintain good signal transmission.

A further object of the present invention is to provide an automatic frequency hopping and channel tracking system for a digital wireless microphone. The system of the present invention includes a digital wireless microphone that has a first digital RF transmitter, a first digital RF receiver, and a decoder; and a digital wireless receiving device that has a second digital RF receiver, a receiving quality detector, a channel selector, an encoder, and a second digital RF transmitter. The channel selector keeps scanning the states of different wireless signal channels to find one wireless signal channel that has lesser adverse factors, such as interferences and noises, and generates RF channel information to the encoder. The encoder encodes the RF channel information to provide channel switching data, which is then transmitted to the digital wireless microphone. In this manner, when a signal transmission between the digital wireless microphone and the digital wireless receiving device is poor in quality, the second digital RF receiver may follow the RF channel information transmitted from the channel selector and switch its current signal channel to a low-interference wireless signal channel selected by the channel selector to thereby achieve the function of quickly switching to another signal channel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an automatic frequency hopping and channel tracking system for an auto-frequency-hopping digital wireless microphone according to a preferred embodiment of the present invention;

FIG. 2 is a flowchart showing the steps of automatic frequency hopping performed by the present invention; and

FIG. 3 is a flowchart showing the steps of channel tracking performed by the present invention.

### DETAILED DESCRIPTION OF THE PREFERRED EMBODIMENTS

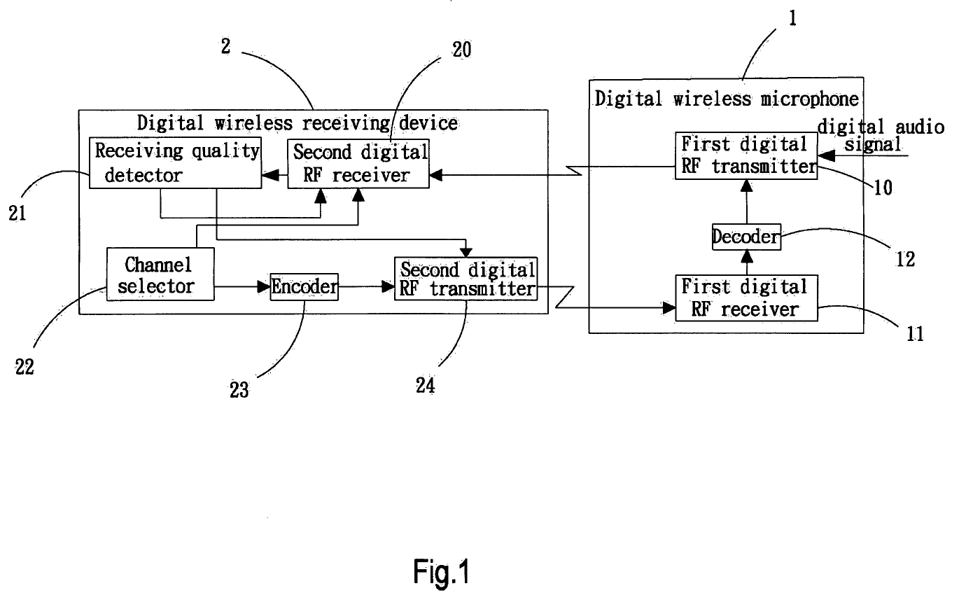

Please refer to FIG. 1 that is a block diagram of an automatic frequency hopping and channel tracking system for an auto-frequency-hopping digital wireless microphone according to a preferred embodiment of the present invention. As shown, the present invention includes a digital wireless microphone 1 and a digital wireless receiving device 2.

The digital wireless microphone 1 includes a first digital radio frequency (RF) transmitter 10, a first digital RF receiver 11, and a decoder 12. The first digital RF transmitter 10 is able to transmit a wireless signal and may change its signal channel. The first digital RF transmitter 10 is also able to encode digital audio signal using an encoding manner, such as encoding to cyclic codes or encoding to convolutional code from the code encoded to Reed-Solomon code, so that the digital information encoded by the first digital RF transmitter 10 is able to be detected, or detected and corrected in the code that is error. The first digital RF receiver 11 is able to receive channel switching data, and the decoder 12 is able to decode the channel switching data into RF channel information, which is then transmitted to the first digital RF transmitter 10 for the latter to switch to another signal channel. Furthermore, the decoder 12 is also able to detect, correct, or detect and correct the code that is error.

The digital wireless receiver 2 includes a second digital RF receiver 20, a receiving quality detector 21, a channel selector 22, an encoder 23, and a second digital RF transmitter 24. The second digital RF receiver 20 is able to receive the wireless signal transmitted by the first digital RF transmitter 10 of the digital wireless microphone 1. Wherein, the encoder 23 encodes digital information using an encoding manner, such as encoding to cyclic codes or encoding to convolutional code from the code encoded to Reed-Solomon code, so that the digital information encoded by the encoder 23 is able to be detected, corrected, or detected and corrected in the code that is error.

The receiving quality detector 21 is electrically connected to the second digital RF receiver 20, and is able to detect from time to time the quality of the wireless signal received by the second digital RF receiver 20 from the first digital RF transmitter 10. When the second digital RF receiver 20 receives a wireless signal having an abnormal quality, the receiving quality detector 21 automatically generates an enable signal. Wherein, the receiving quality detector 21 detects, or detects and corrects the error code of encoded digital audio signal transmitted from the first digital RF transmitter 10, and decides the receiving quality of the second digital RF receiver 20 according to the number of error codes detected.

The channel selector 22 is able to scan from time to time the states of different wireless signal channels, and selects one of the detected wireless signal channels that has lesser adverse factors, such as interference and noise, and generates RF channel information according to the selected low-interference wireless signal channel.

The encoder 23 is electrically connected to the channel selector 22. When it receives the RF channel information transmitted from the channel selector 22, the encoder 23 encodes the received RF channel information to generate channel switching data.

The second digital RF transmitter 24 is electrically connected to the encoder 23 and the receiving quality detector 21, and the second digital RF receiver 20 is electrically connected to the receiving quality detector 21 and the channel selector 22.

When it receives the enable signal from the receiving quality detector 21, the second digital RF transmitter 24 is enabled to generate an RF signal based on the channel switching data transmitted by the encoder 23.

The RF signal is sent out intermittently or periodically. Meanwhile, when it receives the enable signal from the receiving quality detector 21, the second digital RF receiver 20 switches its receiving channel to a channel indicated by the RF channel information transmitted by the channel selector 22.

In this manner, when the signal transmission between the second digital RF receiver 20 and the first digital RF transmitter 10 is subjected to poor signal, high noise, or too many interferences, the first digital RF receiver 11 of the digital wireless microphone 1 will receive the RF signal from the second digital RF transmitter 24 of the digital wireless receiving device 2 so that the first digital RF transmitter 10 follows the RF signal received by the first digital RF receiver 11 to switch its signal channel to the low-interference wireless signal channel selected by the channel selector 22. Then, the digital wireless microphone system is able to transmit and receive signal via the low-interference wireless signal channel without being interfered, and the object of automatic frequency hopping is achieved.

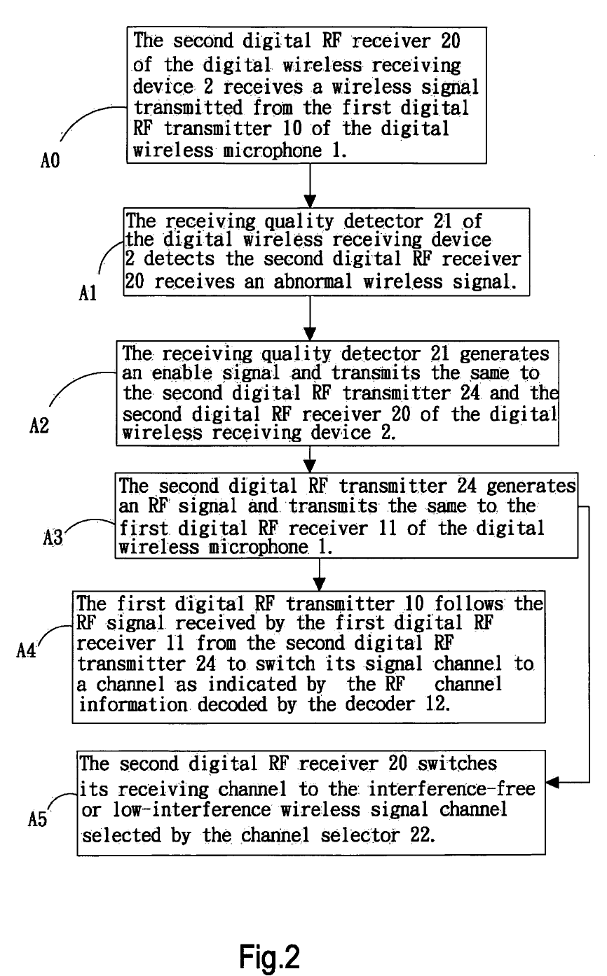

FIG. 2 is a flowchart showing the steps of automatic frequency hopping performed by the present invention according to a preferred embodiment thereof. Please refer to FIGS. 1 and 2 at the same time. The digital wireless microphone 1 and the digital wireless receiving device 2 perform automatic frequency hopping in the following steps:
(A0) The second digital RF receiver 20 of the digital wireless receiving device 2 receives a wireless signal transmitted from the first digital RF transmitter 10;
(A1) The receiving quality detector 21 of the digital wireless receiving device 2 detects the second digital RF receiver 20 receives an abnormal wireless signal:
(A2) The receiving quality detector 21 generates an enable signal and transmits the same to the second digital RF transmitter 24 and the second digital RF receiver 20 of the digital wireless receiving device 2;
(A3) The second digital RF transmitter 24 generates an RF signal and transmits the same to the first digital RF receiver 11 of the digital wireless microphone 1;
(A4) The first digital RF transmitter 10 follows the RF signal received by the first digital RF receiver 11 from the second digital RF transmitter 24 to switch its signal channel to a channel as indicated by the RF channel information decoded by the decoder 12; and
(A5) The second digital RF receiver 20 switches its receiving channel according to the low-interference wireless signal channel selected by the channel selector 22.

When the first digital RF transmitter 10 of the digital wireless microphone 1 transmits a wireless signal to the second digital RF receiver 20 of the digital wireless receiving device 2, and the receiving quality detector 21 detects the wireless signal to be received by the second digital RF receiver 20 is in poor receiving quality, the receiving quality detector 21 generates and transmits an enable signal to the second digital RF transmitter 24. The second digital RF transmitter 24 receiving the enable signal will generate an RF signal and intermittently or periodically transmits the RF signal to the first digital RF receiver 11 of the digital wireless microphone 1. The first digital RF transmitter 10 follows the RF channel information decoded by the decoder 12 to switch its signal channel to an low-interference wireless signal channel selected by the channel selector 22, and the second digital RF receiver 20 receiving the enable signal from the receiving quality detector 21 also switches its receiving channel to the low-interference wireless signal channel according to the RF channel information transmitted by the channel selector 22. Through the synchronous signal channel switching at the digital wireless microphone 1 and the digital wireless receiving device 2, it is able to avoid the current abnormal signal channel and switch to a signal channel allowing good signal communication.

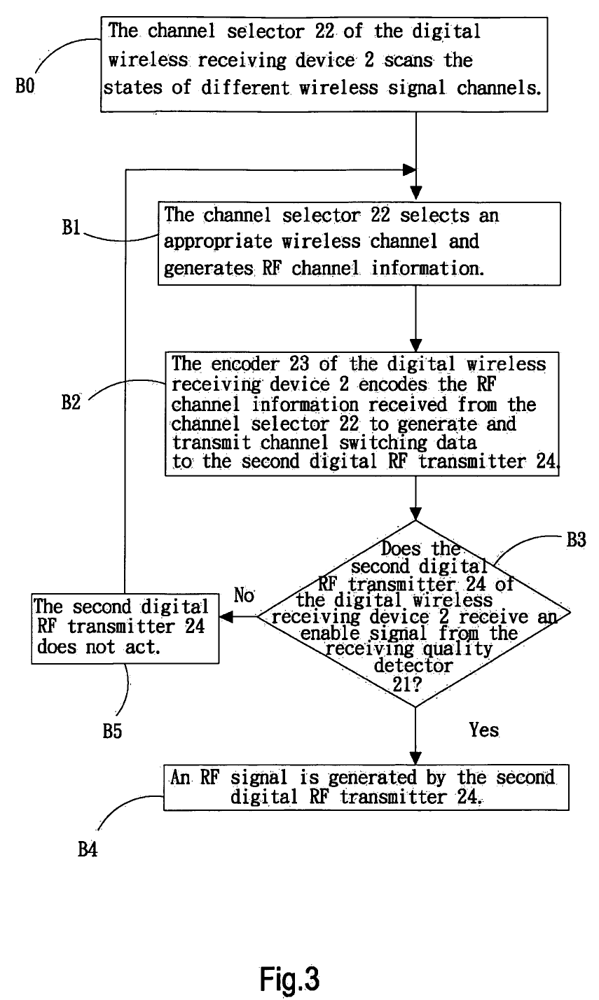

FIG. 3 is a flowchart showing the steps of channel tracking performed by the present invention according to a preferred embodiment thereof. Please refer to FIGS. 1 and 3 at the same time. The digital wireless microphone 1 and the digital wireless receiving device 2 perform channel tracking in the following steps:
(B0) The channel selector 22 of the digital wireless receiving device 2 scans the states of different wireless signal channels;
(B1) The channel selector 22 selects an appropriate wireless channel and generates proper RF channel information;
(B2) The encoder 23 encodes the RF channel information received from the channel selector 22 to generate and transmit channel switching data to the second digital RF transmitter 24;
(B3) It is checked whether the second digital RF transmitter 24 of the digital wireless receiving device 2 receives an enable signal from the receiving quality detector 21; if yes, go to step (B4), and if no, go to step (B5);
(B4) An RF signal is generated by the second digital RF transmitter 24; or
(B5) The second digital RF transmitter 24 does not act, and the channel selector 22 continues scanning the states of different wireless signal channels.

In performing the channel tracking, the channel selector 22 keeps scanning the states of different wireless signal channels to find a wireless signal channel has lesser adverse factors, such as interference and noise, and generates and transmits RF channel information to the encoder 23. The encoder 23 encodes the received RF channel information to generate channel switching data. Whereby, when the wireless signal received by the second digital RF receiver 20 from the first digital RF transmitter 10 is poor or abnormal in quality, the first digital RF transmitter 10 of the digital wireless microphone 1 and the second digital RF receiver 20 of the digital wireless receiving device 2 may quickly and synchronously switch according to the RF channel information from the current abnormal signal channel to another low-interference wireless signal channel as selected by the channel selector 22.

In summary, the automatic frequency hopping and channel tracking system for an auto-frequency-hopping digital wireless microphone according to the present invention improves the prior art microphones due to the following reasons:

The digital wireless microphones 1 includes the first digital RF transmitter 10, the first digital RF receiver 11, and the decoder 12; and the digital wireless receiving device 2 includes the second digital RF receiver 20, the receiving quality detector 21, the channel selector 22, the encoder 23, and the second digital RF transmitter 24. When the second digital RF receiver 20 receives a wireless signal transmitted by the first digital RF transmitter 10, and the receiving quality detector 21 detects that the data to be received by the second digital RE receiver 20 is in poor receiving quality, the receiving quality detector 21 would generate the enable signal that is transmitted to the second digital RF transmitters 24 for the latter to generate an RF signal, which is intermittently or periodically transmitted to the first digital RF receiver 11. Encoded channel information in the RF signal transmitted from the second digital RF transmitter 24 is decoded by the decoder 12 in the digital wireless microphone 1, so that the first digital RF transmitter 10 follows the decoded channel information to switch the current signal channel to a low-interference wireless signal channel. Meanwhile, on receipt of the enable signal from the receiving quality detector 21, the second digital RF receiver 20 will synchronously switch its receiving channel to the low-interference wireless signal channel as selected by the channel selector 22. That is, when the receiving quality detector 21 detects a poor receiving quality, the signal channel is synchronously switched to a low-interference wireless signal channel as selected by the channel selector 22. Then, it is able to avoid the current abnormal signal channel and to transmit and receive signal without being interfered. Thereafter, the RF signal transmission from the second digital RF transmitter 24 stops when a preset period of time has lapsed or when the receiving quality detector 21 determines the quality of signal has reached a preset level.

Further, when the RF signal transmitted by the second digital RF transmitter 24 of the digital wireless receiving device 2 is interfered by high energy, which is noise, the channel switching data may be otherwise transmitted at a lower data transmission rate, in order to increase the signal to noise ratio (SNR) of the signal received by the first digital RF receiver 11 of the digital wireless microphone 1. Furthermore, the second digital RF transmitter 24 may transmit the RF signal using the spread spectrum technique in order to resist interference by noise. The spread spectrum system may be divided into two forms, namely, direct-sequence spread spectrum (DSSS) and frequency-hopping spread spectrum (FHSS).

In DSSS, a pseudorandom sequence code is used to spread the spectrum of the transmitted RF signal. When the second digital RF transmitter 24 of the digital wireless receiving device 2 uses DSSS to modulate the RF signal to be transmitted, the pseudorandom sequence code is used to spread the spectrum of the RF signal transmitted by the second digital RF transmitter 24. Thereafter, when the first digital RF receiver 11 of the digital wireless microphone 1 receives the RF signal from the second digital RF transmitter 24, pseudorandom sequence code the same as and synchronous with that used by the second digital RF transmitter 24 must be used to dspread the RF signal received from the second digital RF transmitter 24, so as to increase the signal to noise ratio of the signal received by the first digital RF receiver 11.

In FHSS, random sequence code is used to change the transmitting channel of the RF signal. When the second digital RF transmitter 24 transmits the RF signal using FHSS, the transmitting channel of the RF signal is changed using random sequence code, so that the channel used to transmit the RF signal may be randomly changed with time. Thereafter, when the first digital RF receiver 11 receives the RE signal from the second digital RF transmitter 24, random sequence code the same as and synchronous with that used by the second digital RF transmitter 24 is used to demodulate the RF signal transmitted by the second digital RF transmitter 24. Therefore, the transmission of the RF signal via a random channel may reduce the possibility of signal interference by high energy noise at some specific channel, and accordingly increase the accuracy of received data and achieve the purpose of good signal transmission.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An automatic frequency hopping and channel tracking system for an auto-frequency-hopping digital wireless microphone, comprising a digital wireless microphone and a digital wireless receiving device;
the digital wireless microphone including:
a first digital RF transmitter capable of transmitting a wireless signal, encoding a digital audio signal, and switching to a different wireless signal transmitting channel; and
a first digital RF receiver being electrically connected to the first digital RF transmitter for receiving RF channel information transmitted by the second digital RF transmitter of the digital wireless receiving device; and
the digital wireless receiving device including:
a second digital RF receiver for receiving encoded digital audio signal transmitted from the first digital RF transmitter, and capable of switching to a different wireless signal receiving channel;
a receiving quality detector being electrically connected to the second digital RF receiver, and capable of generating an enable signal when it detects the data to be received by the second digital RF receiver is in poor receiving quality;
a channel selector being electrically connected to the second digital RF receiver for scanning states of different wireless signal channels and generating appropriate RF channel information; and
a second digital RF transmitter being electrically connected to the channel selector and the receiving quality detector; whereby when the second digital RF transmitter receives the enable signal transmitted by the receiving quality detector, the second digital RF transmitter generates an RF signal according to the RF channel information generated by the channel selector.

2. The automatic frequency hopping and channel tracking system for an auto-frequency-hopping digital wireless microphone as claimed in claim 1, wherein digital wireless receiving device further includes an encoder, which encodes digital information in an encoding manner that the error code may be detected, corrected, or detected and corrected; the encoder being capable of receiving the RF channel information and encoding the received RF channel information to generate channel switching data; and the encoder being electrically connected to the channel selector and the second digital RF transmitter.

3. The automatic frequency hopping and channel tracking system for an auto-frequency-hopping digital wireless microphone as claimed in claim 1, wherein the first digital RF receiver of the digital wireless microphone receives the wireless RF signal transmitted by the second digital RF transmitter of the digital wireless receiving device.

4. The automatic frequency hopping and channel tracking system for an auto-frequency-hopping digital wireless microphone as claimed in claim 2, wherein the digital wireless microphone further includes a decoder that is able to detect, correct, or detect and correct the code that is error; and wherein the second digital RF transmitter of the digital wireless receiving device receives the channel switching data generated by the encoder and sends the received channel switching data to the first digital RF receiver of the digital wireless microphone; and wherein the channel switching data received by the first digital RF receiver is decoded by the decoder to generate the RF channel information, which is then sent to the first digital RF transmitter.

5. The automatic frequency hopping and channel tracking system for an auto-frequency-hopping digital wireless microphone as claimed in claim 1, wherein the second digital RF transmitter intermittently or periodically transmits the RF signal.

6. The automatic frequency hopping and channel tracking system for an auto-frequency-hopping digital wireless microphone as claimed in claim 1, wherein the second digital RF transmitter uses a pseudorandom sequence code to spread the spectrum of the RF signal generated by the second digital RF transmitter.

7. The automatic frequency hopping and channel tracking system for an auto-frequency-hopping digital wireless microphone as claimed in claim 1, wherein the second digital RF transmitter of the digital wireless receiving device transmits the RF signal via a transmitting channel that may be randomly changed with time.
